(19) United States
(12) Patent Application Publication
(10) Pub. No.: US 2025/0015377 A1
(43) Pub. Date: Jan. 9, 2025

(54) BATTERY PACK

(71) Applicant: MURATA MANUFACTURING CO., LTD., Kyoto (JP)

(72) Inventors: Yoshiyuki BANNAI, Kyoto (JP); Junichi IKEDA, Kyoto (JP); Hiroshi KAWAMURA, Kyoto (JP)

(21) Appl. No.: 18/888,438

(22) Filed: Sep. 18, 2024

Related U.S. Application Data
(63) Continuation of application No. PCT/JP2023/001775, filed on Jan. 20, 2023.

(30) Foreign Application Priority Data
Mar. 30, 2022 (JP) 2022-057361

(51) Int. Cl. H01M 10/52; H01M 10/653; H01M 50/213; H01M 50/291

(52) U.S. Cl. CPC H01M 10/52; H01M 10/653; H01M 50/213; H01M 50/291

(57) ABSTRACT

A battery pack is provided and includes a plurality of cylindrical cells arranged in a manner that electrode terminals face the same direction, and an embedded member arranged between a plurality of the cylindrical cells. The embedded member includes a container, and a heat absorbing agent and gas accommodated in the container. The container is provided with a projecting portion arranged between two adjacent ones of the cylindrical cells and extending in a longitudinal direction of the cylindrical cell as viewed from a longitudinal direction of the cylindrical cell. The projecting portion includes a heat absorbing agent accommodation portion in which a heat absorbing agent is accommodated and a gas accommodation portion in which gas is accommodated. The gas accommodation portion is arranged at a tip portion of the projecting portion and is in contact with each of two adjacent ones of the cylindrical cells.

### CROSS REFERENCE TO THE RELATED APPLICATIONS

The present application is a continuation of PCT patent application no. PCT/JP2023/001775, filed on Jan. 20, 2023, which claims priority to Japanese patent application no. 2022-057361, filed on Mar. 30, 2022, the entire contents of which are incorporated herein by reference.

### BACKGROUND

The present disclosure relates to a battery pack.

A battery unit provided in a battery pack has a plurality of cells. In a case where the cell is a cylindrical cell, a plurality of cylindrical cells are arranged in a direction orthogonal to a longitudinal direction of the cylindrical cell. Further, a plurality of the cylindrical cells are arranged in a manner that electrode terminals are located on the same plane. If abnormal heat generation occurs in one cylindrical cell, an adjacent cylindrical cell may be heated and ignited. In order to prevent such induced explosion (heating and ignition of an adjacent cylindrical cell), there is a case where an embedded member is arranged between a cylindrical cell and a cylindrical cell. Further, an embedded member of a patent document below includes a container made from resin and a heat absorbing agent accommodated in the container. Then, in a case where abnormal heat generation occurs in a cylindrical cell, a part of the container is melted (opened), and the heat absorbing agent is discharged.

### SUMMARY

The present disclosure relates to a battery pack.

However, according to the embedded member, since the heat absorbing agent accommodated inside absorbs heat transmitted from a cylindrical cell to the container, temperature rise of the container is suppressed. That is, melting of the container is delayed, and the container is not quickly opened.

In view of the above problem, for example, the present disclosure, in an embodiment, relates to providing a battery pack in which a container of an embedded member is opened early in a case where abnormal heat generation occurs in a cylindrical cell.

A battery pack of an embodiment of the present disclosure includes a plurality of cylindrical cells arranged in a manner that electrode terminals face the same direction, and an embedded member arranged between a plurality of the cylindrical cells. The embedded member includes a container, and a heat absorbing agent and gas accommodated in the container. The container is provided with a projecting portion arranged between two adjacent ones of the cylindrical cells and extending in a longitudinal direction of the cylindrical cell as viewed from a longitudinal direction of the cylindrical cell. The projecting portion includes a heat absorbing agent accommodation portion in which a heat absorbing agent is accommodated and a gas accommodation portion in which gas is accommodated. The gas accommodation portion is arranged at a tip portion of the projecting portion and is in contact with each of two adjacent ones of the cylindrical cells.

According to the battery pack of the present disclosure, in an embodiment, the gas accommodation portion melts early, and supply of the heat absorbing agent is accelerated. This suppresses induced explosion.

### BRIEF DESCRIPTION OF THE FIGURES

FIG. 1 is an exploded perspective view of a battery pack according to an embodiment.

FIG. 2 is an exploded perspective view of a battery unit.

FIG. 3 is a perspective view of an embedded member of an embodiment.

FIG. 4 is a sectional view taken along line IV-IV in FIG. 3.

FIG. 5 is an exploded perspective view of the embedded member of an embodiment.

FIG. 6 is an enlarged diagram of a first projecting portion of an embodiment.

FIG. 7 is a sectional view taken along line VII-VII in FIG. 4.

FIG. 8 is a diagram in a case where abnormal heat generation occurs in a first cell of an embodiment.

FIG. 9 is a sectional view of an embedded member of a first variation taken along a longitudinal direction.

FIG. 10 is a perspective view of the embedded member of an embodiment.

FIG. 11 is a perspective view of the embedded member of an embodiment.

FIG. 12 is a sectional view of the first projecting portion of an embodiment.

FIG. 13 is a diagram of the battery unit of a fourth variation as viewed from the longitudinal direction.

FIG. 14 is an enlarged diagram of the first projecting portion of an embodiment.

FIG. 15 is a perspective view of the embedded member of an embodiment.

FIG. 16 is a sectional view of the embedded member of an embodiment taken along a planar direction.

FIG. 17 is a diagram of the battery unit of an embodiment as viewed from the longitudinal direction.

FIG. 18 is a sectional view of the embedded member of an embodiment.

FIG. 19 is a perspective view of the embedded member of an embodiment.

FIG. 20 is a sectional view of the embedded member of an embodiment taken along the planar direction.

FIG. 21 is a diagram of the battery unit of an embodiment as viewed in the longitudinal direction.

### DETAILED DESCRIPTION

Hereinafter, the present disclosure will be described in further detail including with reference to the drawings according to an embodiment. The present disclosure is not limited thereto. Further, constituent elements disclosed in an embodiment below can be suitably combined with each other.

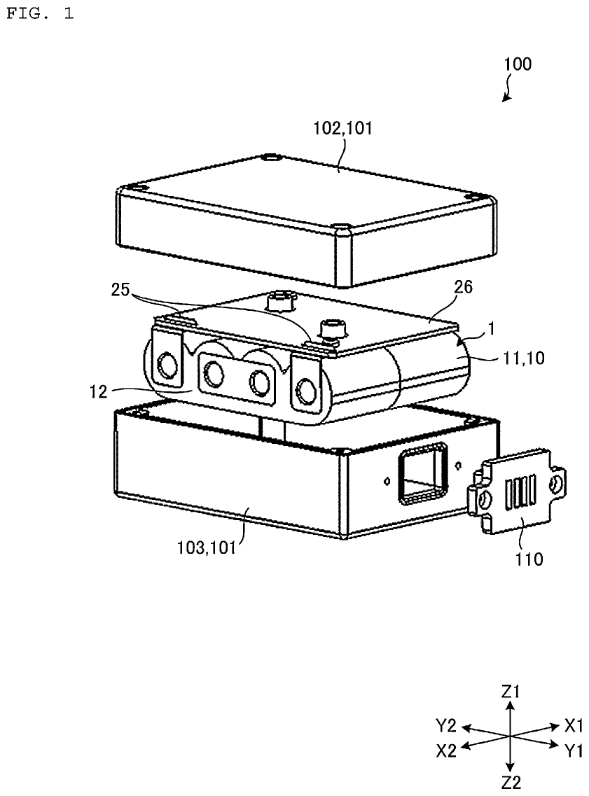

FIG. 1 is an exploded perspective view of a battery pack 100 according to a first embodiment. As illustrated in FIG. 1, the battery pack 100 includes a battery unit 1 and a case 101 in which the battery unit 1 is accommodated.

The case 101 is a housing made from resin. The case 101 includes a first case 102 and a second case 103 divided in a vertical direction. The first case 102 is arranged above the second case 103 in the vertical direction. Hereinafter, the upper side in the vertical direction is referred to as an upper side Z1. The lower side in the vertical direction is referred to as a lower side Z2. Further, a direction orthogonal to the vertical direction is referred to as a horizontal direction.

The first case 102 has a bottomed cylindrical shape opened to the lower side Z2. The second case 103 is formed in a bottomed cylindrical shape opened to the upper side Z1. The first case 102 and the second case 103 are fastened by a bolt (not illustrated). An external terminal 110 is provided on a wall portion of the second case 103. The external terminal 110 is connected to two electrode tabs 25 of the battery unit 1.

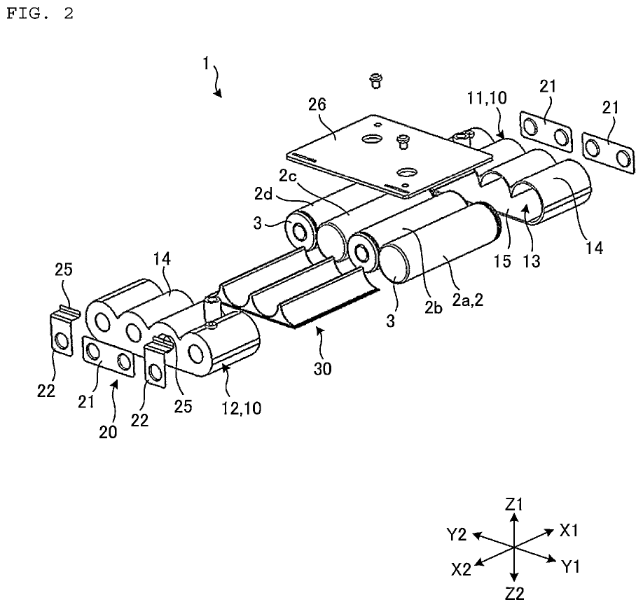

FIG. 2 is an exploded perspective view of the battery unit. As illustrated in FIG. 2, the battery unit 1 includes four cylindrical cells 2, a cell holder 10, a tab 20, a control board 26, and an embedded member 30. Hereinafter, a direction in which the cylindrical cell 2 extends is referred to as a longitudinal direction. Electrode terminals 3 are provided at both ends in the longitudinal direction of the cylindrical cell 2.

Each of four of the cylindrical cells 2 is arranged so as to be parallel to the horizontal direction. Further, four of the cylindrical cells 2 are arranged in a manner that the electrode terminals 3 face the same direction. Further, four of the cylindrical cells 2 are arranged in order in a direction (hereinafter, referred to as a width direction) orthogonal to both the vertical direction and the longitudinal direction. Furthermore, four of the cylindrical cells 2 are arranged in a manner that the electrode terminals 3 are located on the same plane. Note that the same plane is a plane extending in the width direction and the vertical direction. Hereinafter, a direction parallel to the same plane is referred to as a planar direction. Other than the above, in the battery pack of the present disclosure, a plurality of the electrode terminals 3 do not need to be arranged on the same plane. That is, a plurality of the electrode terminals 3 may be arranged so as to be shifted in the longitudinal direction.

The width direction in which four of the cylindrical cells 2 are arranged is a direction in which the external terminals 110 are arranged as viewed from the inside of the case 101 (see FIG. 1). Hereinafter, as viewed from the cylindrical cell 2, a direction in which the external terminal 110 is arranged is referred to as a first width direction Y1, and a direction opposite to the first width direction Y1 is referred to as a second width direction Y2. Further, four of the cylindrical cells 2 may be referred to as a first cylindrical cell 2a, a second cylindrical cell 2b, a third cylindrical cell 2c, and a fourth cylindrical cell 2d in this order from the first width direction Y1.

The cell holder 10 includes a first cell holder 11 and a second cell holder 12. The first cell holder 11 is arranged on one side in the longitudinal direction with respect to four of the cylindrical cells 2. Further, the first cell holder 11 is a resin product. The second cell holder 12 is arranged on another side in the longitudinal direction with respect to four of the cylindrical cells 2. Further, the second cell holder 12 is a resin product. Hereinafter, a direction in which the first cell holder 11 is arranged as viewed from four of the cylindrical cells 2 is referred to as a first longitudinal direction X1, and the opposite direction is referred to as a second longitudinal direction X2.

Each of the first cell holder 11 and the second cell holder 12 is provided with a cell accommodation portion 13. The cell accommodation portion 13 is a hole extending in the longitudinal direction, and accommodates an end portion of the cylindrical cell 2. Further, the cell accommodation portion 13 extends in the width direction and can accommodate four of the cylindrical cells 2.

An upper wall portion 14 on the upper side Z1 of the cell accommodation portion 13 includes four continuous arc-shaped walls in the width direction. That is, the upper wall portion 14 extends along an outer peripheral surface of four of the cylindrical cells 2. On the other hand, a lower wall portion 15 on the lower side Z2 of the cell accommodation portion 13 is linear in the width direction. Therefore, a space in which the embedded member 30 is arranged is provided between the cylindrical cell 2 and the lower wall portion 15.

The tab 20 is a metal plate extending in the planar direction. A plurality of the tabs 20 include a plurality of first tabs 21 and a plurality of second tabs 22. The first tab 21 connects the electrode terminals 3 of two of the cylindrical cells 2 adjacent to each other in the width direction. The second tab 22 is provided with an electrode tab 25. Each of the first tab 21 and the second tab is welded to the electrode terminal 3 of the cylindrical cell 2.

The control board 26 is arranged on the upper side Z1 of the cell holder 10, and is fixed to the cell holder 10 by a screw. The control board 26 suppresses overdischarge and overcharge of the cylindrical cell 2.

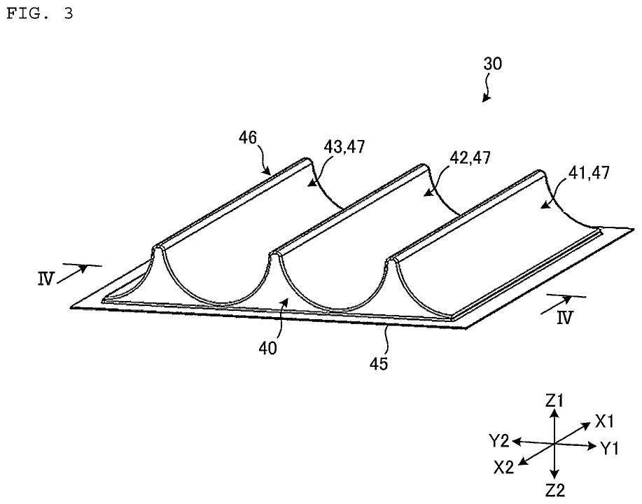

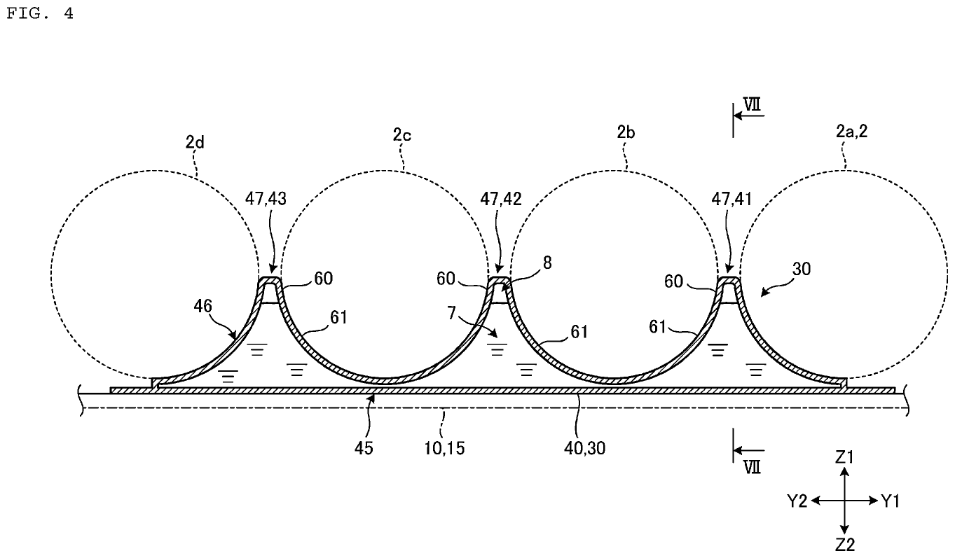

FIG. 3 is a perspective view of the embedded member of the first embodiment. FIG. 4 is a sectional view taken along IV-IV of FIG. 3. As illustrated in FIGS. 3 and 4, the embedded member 30 includes a container 40 having a sealed internal space, and a heat absorbing agent 7 and gas 8 (see FIG. 4) accommodated in the container 40.

The container 40 is a housing made from resin. The resin preferably contains thermoplastic resin that is easily melted by abnormal heat generation of the cylindrical cell 2. Specific examples include polypropylene (PP), polystyrene (PS), and polyethylene (PE).

The heat absorbing agent 7 is liquid containing water as a main component. In a case where gel is applied as a form of the heat absorbing agent 7, it is desirable to use synthetic polymer gel. As the synthetic polymer gel, for example, sodium polyacrylate, polyvinyl alcohol, polyhydroxyethyl methacrylate, or silicone hydrogel can be used. Other than the above, a form of the heat absorbing agent 7 may be sol.

Examples of the gas 8 include air, but a kind of the gas 8 is not particularly limited. The gas 8 has specific gravity smaller than that of the heat absorbing agent 7. Therefore, in a case of being accommodated in the container 40, the gas 8 is arranged on the upper side Z1, and the heat absorbing agent 7 is arranged on the lower side Z2 of the gas 8. Further, an amount of heat absorbed by the gas 8 is extremely small as compared with that by the heat absorbing agent 7.

Further, the gas 8 is contained in the container 40 by a method below. The heat absorbing agent 7 is sufficiently stirred and the gas 8 is mixed in the heat absorbing agent 7. In this state, the heat absorbing agent 7 is accommodated in the container. Alternatively, when the heat absorbing agent 7 is accommodated in the container 40, a space in the container 40 is not filled with the heat absorbing agent 7, and a part of the space is left unfilled.

As illustrated in FIG. 4, the container 40 includes a lower member 45 extending in the horizontal direction along the lower wall portion 15 of the cell accommodation portion 13 and an upper member 46 covering the upper side Z1 of the lower member 45. Then, an internal space is formed between the lower member 45 and the upper member 46. Note that FIG. 4 is a diagram in which only the embedded member 30 is extracted from the battery pack 100. For this reason, the cylindrical cell 2 and the lower wall portion 15 arranged in the vicinity of the embedded member 30 are illustrated by a virtual line.

The upper member 46 is provided with three projecting portions 47 projecting to the upper side Z1. Three of the projecting portions 47 are arranged between two adjacent ones of the cylindrical cells 2. That is, the container 40 is provided with a first projecting portion 41 arranged between the first cylindrical cell 2a and the second cylindrical cell 2b, a second projecting portion 42 arranged between the second cylindrical cell 2b and the third cylindrical cell 2c, and a third projecting portion 43 arranged between the third cylindrical cell 2c and the fourth cylindrical cell 2d. Further, internal spaces of the first projecting portion 41, the second projecting portion 42, and the third projecting portion 43 are continuous. Hereinafter, the first projecting portion 41 will be described as a representative example, and description of the second projecting portion 42 and the third projecting portion 43 will be omitted.

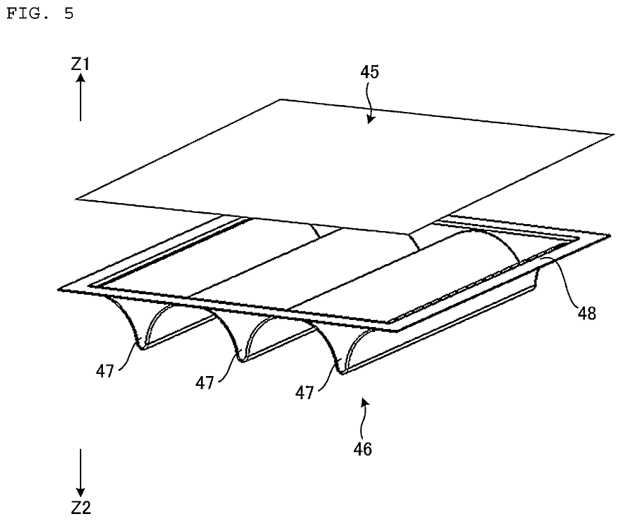

FIG. 5 is an exploded perspective view of the embedded member of the first embodiment. Note that, as illustrated in FIG. 5, the upper member 46 is provided with a frame-shaped frame portion 48. The projecting portion 47 of the upper member 46 is arranged so as to face the lower side Z2, and the heat absorbing agent 7 and the gas 8 are accommodated inside the frame portion 48. After the above, the lower member 45 is placed from the upper side Z1 of the frame portion 48. Then, the frame portion 48 and the lower member 45 are joined by thermal welding or the like. By the above, the lower member 45 and the upper member 46 are integrated, and the inside of the container 40 is sealed.

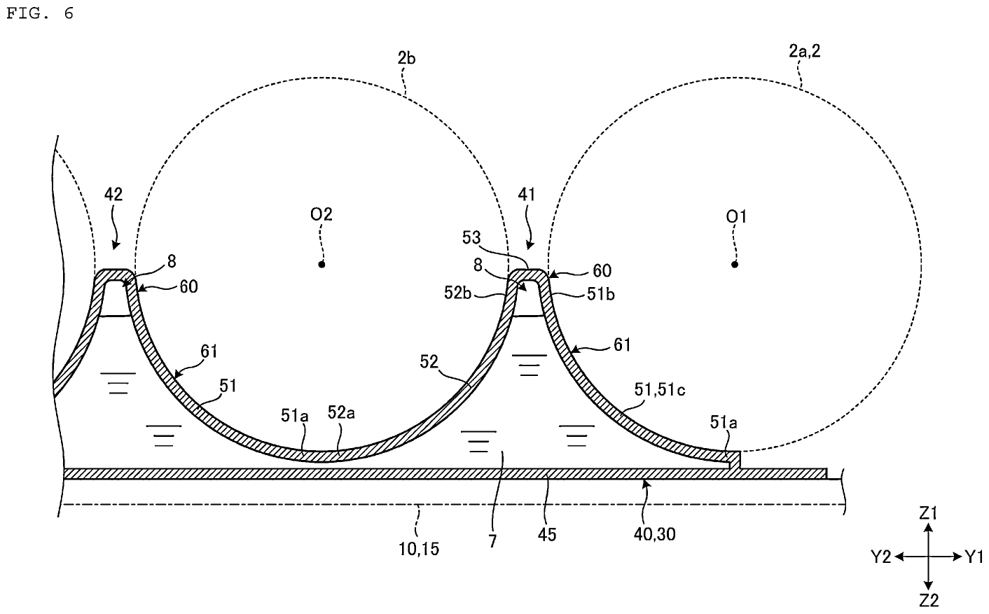

FIG. 6 is an enlarged diagram of the first projecting portion of the first embodiment. Note that FIG. 6 is a diagram in which only the embedded member 30 is extracted from the battery pack 100. For this reason, the cylindrical cell 2 and the lower wall portion 15 arranged in the vicinity of the embedded member 30 are illustrated by a virtual line. As illustrated in FIG. 6, the first projecting portion 41 includes a first arcuate wall 51, a second arcuate wall 52, and a connection portion 53. The connection portion 53 is arranged between the first cylindrical cell 2a and the second cylindrical cell 2b and extends in the width direction.

The first arcuate wall 51 is arranged further in the first width direction Y1 than the connection portion 53. The first arcuate wall 51 has an arcuate shape. The first arcuate wall 51 extends along an outer peripheral surface of the first cylindrical cell 2a. That is, the entire surface on the outer peripheral side of the first arcuate wall 51 abuts on an outer peripheral surface of the first cylindrical cell 2a.

The second arcuate wall 52 is arranged further in the second width direction Y2 than the connection portion 53. The second arcuate wall 52 has an arcuate shape. The second arcuate wall 52 extends along an outer peripheral surface of the second cylindrical cell 2b. That is, the entire surface on the outer peripheral side of the second arcuate wall 52 abuts on an outer peripheral surface of the second cylindrical cell 2b.

A space between the first arcuate wall 51 and the second arcuate wall 52 gradually narrows toward the upper side Z1. An end portion 51a in the first width direction Y1 of the first arcuate wall 51 is continuous with the lower member 45. An end portion 52a in the second width direction Y2 of the second arcuate wall 52 is connected to the end portion 51a in the first width direction Y1 of the first arcuate wall 51 of the second projecting portion 42. Then, an internal space of the first projecting portion 41 and an internal space of the second projecting portion 42 are continuous.

The heat absorbing agent 7 and the gas 8 are accommodated in the first projecting portion 41. The heat absorbing agent 7 and the gas 8 having small specific gravity in the gas 8 are arranged on the upper side Z1 in the first projecting portion 41. Therefore, when viewed from the longitudinal direction, the first projecting portion 41 is divided into a gas accommodation portion 60 which is arranged at a tip portion of the first projecting portion 41 and accommodates the gas 8 in the inside and a heat absorbing agent accommodation portion 61 which is arranged further on the lower side Z2 than the gas accommodation portion 60 and accommodates the heat absorbing agent 7 in the inside. That is, the first projecting portion 41 includes the heat absorbing agent accommodation portion 61 in which the heat absorbing agent 7 is accommodated and the gas accommodation portion 60 in which the gas 8 is accommodated.

Note that the gas accommodation portion 60 includes an end portion 51b near the connection portion 53 of the first arcuate wall 51, an end portion 52b near the connection portion 53 of the second arcuate wall 52, and the connection portion 53. Therefore, the gas accommodation portion 60 is in contact with each of two adjacent ones of the cylindrical cells 2 (the first cylindrical cell 2a and the second cylindrical cell 2b). Hereinafter, for convenience of description, a portion excluding the end portion 51b of the first arcuate wall 51 (a portion constituting the heat absorbing agent accommodation portion 61) is referred to as a heat absorbing agent wall portion 51c.

The connection portion 53 is arranged between a center O1 of the first cylindrical cell 2a and a center O2 of the second cylindrical cell 2b. Therefore, the connection portion 53 (gas accommodation portion 60) is arranged at a narrowest place between an outer peripheral surface of the first cylindrical cell 2a and an outer peripheral surface of the second cylindrical cell 2b.

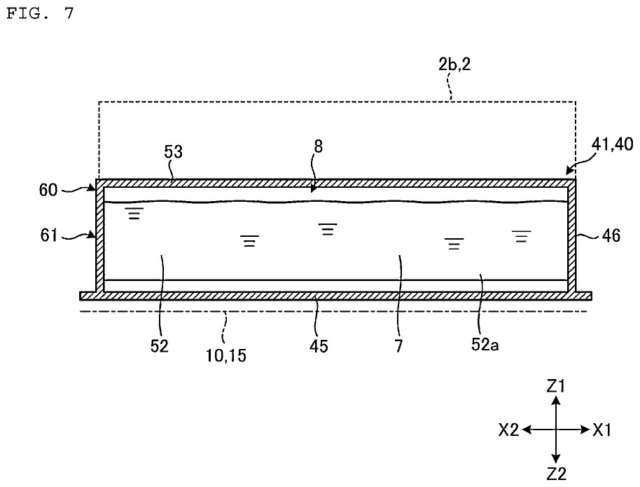

FIG. 7 is a sectional view taken along line VII-VII in FIG. 4. Note that FIG. 7 is a diagram in which only the embedded member 30 is extracted from the battery pack 100. For this reason, the cylindrical cell 2 and the lower wall portion 15 arranged in the vicinity of the embedded member 30 are illustrated by a virtual line. As illustrated in FIG. 7, the first projecting portion 41 extends in the longitudinal direction. The first projecting portion 41 has the same length as the length in the longitudinal direction of the cylindrical cell 2. Therefore, the gas accommodation portion 60 abuts on the entirety of the first cylindrical cell 2a and the second cylindrical cell 2b in the longitudinal direction. Further, the gas 8 is continuous in the longitudinal direction inside the gas accommodation portion 60. More specifically, the gas 8 is continuous over the entirety in the longitudinal direction of the gas accommodation portion 60.

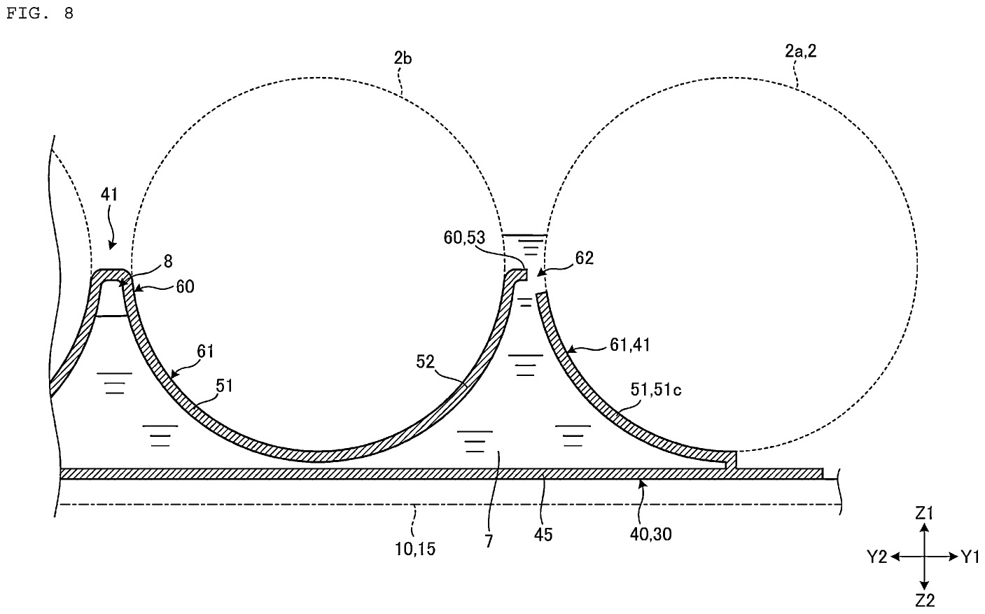

FIG. 8 is a diagram in a case where abnormal heat generation occurs in the first cell in the first embodiment. Note that FIG. 8 is a diagram in which only the embedded member 30 is extracted from the battery pack 100. For this reason, the cylindrical cell 2 and the lower wall portion 15 arranged in the vicinity of the embedded member 30 are illustrated by a virtual line. Next, a case where abnormal heat generation occurs in the cylindrical cell 2 will be described. Note that, in description below, a case where abnormal heat generation occurs in the first cylindrical cell 2a among four of the cylindrical cells 2 will be described as an example.

In a case where abnormal heat generation occurs in the first cylindrical cell 2a, heat is transferred to the first projecting portion 41 abutting on an outer peripheral surface of the first cylindrical cell 2a. Specifically, heat is transferred to the first arcuate wall 51 of the first projecting portion 41. Here, the heat absorbing agent wall portion 51c of the first arcuate wall 51 constitutes a wall portion of the heat absorbing agent accommodation portion 61 and is in contact with the heat absorbing agent 7. Therefore, heat transferred to the heat absorbing agent wall portion 51c is absorbed by the heat absorbing agent 7. On the other hand, the end portion 51b of the first arcuate wall 51 constitutes a wall portion of the gas accommodation portion 60 and is in contact with the gas 8 (see FIG. 6). Further, an amount of heat absorbed by the gas 8 is extremely small as compared with that by the heat absorbing agent 7. For this reason, as illustrated in FIG. 8, the end portion 51b of the first arcuate wall 51 melts earlier than the heat absorbing agent wall portion 51c. That is, a tear 62 is generated in the gas accommodation portion 60 of the first projecting portion 41, and the container 40 is opened.

Further, the inside of the container 40 is heated by the first cylindrical cell 2a, and internal pressure increases. Therefore, the heat absorbing agent 7 is discharged from the tear 62 of the gas accommodation portion 60 and flows out between the first cylindrical cell 2a and the second cylindrical cell 2b.

Then, the heat absorbing agent 7 comes into contact with an outer peripheral surface of the first cylindrical cell 2a and absorbs heat from the first cylindrical cell 2a. This suppresses temperature rising of the first cylindrical cell 2a. Furthermore, the heat absorbing agent 7 comes into contact with an outer peripheral surface of the second cylindrical cell 2b and absorbs heat from the second cylindrical cell 2b. By the above, in the second cylindrical cell 2b, heat applied by the first cylindrical cell 2a is absorbed by the heat absorbing agent 7, and heating of the second cylindrical cell 2b is suppressed.

Further, the gas accommodation portion 60 abuts on the entirety of the first cylindrical cell 2a and the second cylindrical cell 2b in the longitudinal direction. For this reason, if abnormal heat generation occurs at any position in the longitudinal direction of the cylindrical cell 2a and the cylindrical cell 2b, a tear is generated in the gas accommodation portion 60, and the heat absorbing agent 7 can be allowed to flow out.

As described above, according to the first embodiment, the gas accommodation portion 60 is opened earlier than the heat absorbing agent accommodation portion 61. In accordance with the above, the heat absorbing agent 7 is supplied early, and as a result, induced explosion of the cylindrical cell 2 is suppressed.

Although the first embodiment is described above, the present disclosure is not limited to the example shown in the first embodiment. For example, in the first embodiment, in a tip portion of the first projecting portion 41, the gas 8 is continuously accommodated over the entirety in length direction. However, in the present disclosure, the gas 8 does not need to be continuous over the entirety in the longitudinal of the gas accommodation portion 60 (projecting portion 47). Hereinafter, an embedded member 30A of the first variation will be described.

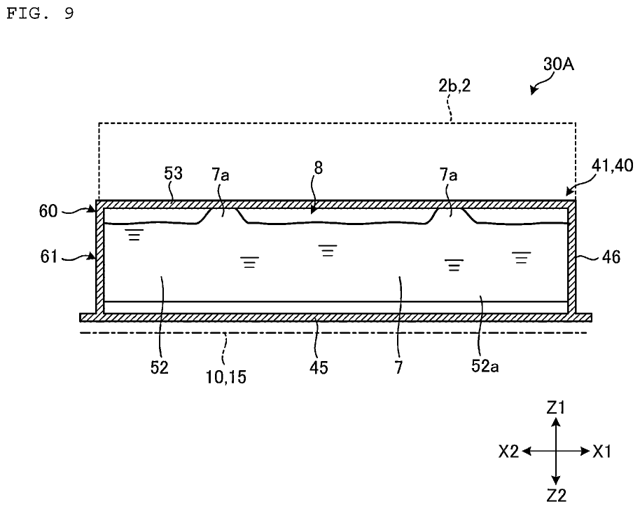

FIG. 9 is a sectional view of the embedded member of a first variation taken along the longitudinal direction according to an embodiment. Note that FIG. 9 is a diagram in which only the embedded member 30A is extracted from the battery pack. For this reason, the cylindrical cell 2 and the lower wall portion 15 arranged in the vicinity of the embedded member 30A are illustrated by a virtual line. The heat absorbing agent 7 has high adhesiveness. Therefore, as illustrated in FIG. 9, as in the embedded member 30A of the first variation, a part 7a of the heat absorbing agent 7 may adhere to an inner surface of the connection portion 53. For this reason, the gas 8 and the heat absorbing agent 7 may be accommodated in a tip portion (inside of a wall portion surrounded by the end portion 51b of the first arcuate wall 51, the end portion 52b of the second arcuate wall 52, and the connection portion 53) of the first projecting portion 41. That is, a tip portion of the first projecting portion 41 may include the gas accommodation portion 60 that accommodates the gas 8 and the heat absorbing agent accommodation portion 61 that accommodates the part 7a of the heat absorbing agent 7.

According to the first variation, a tip portion of the first projecting portion 41 has a portion where heat is absorbed by the part 7a of the heat absorbing agent 7, but has a portion where the gas 8 is accommodated and heat is not absorbed. Therefore, in a case where abnormal heat generation occurs in the cylindrical cell 2, the gas accommodation portion 60, which is a part of a tip portion of the first projecting portion 41, melts early. Therefore, also in the first variation, similarly to the first embodiment, the heat absorbing agent 7 can be supplied at an early stage, and induced explosion is suppressed.

Further, in the present disclosure, the gas 8 accommodated in the gas accommodation portion 60 may be an air bubble. In other words, bubbles (the gas 8) may be scattered in the length direction in the gas accommodation portion 60. In such an example as well, a portion where bubbles (the gas 8) are arranged melts early. From the above, in the present disclosure, the gas 8 accommodated in the gas accommodation portion 60 may be a bubble, and length of the gas 8 continuous in the longitudinal direction is not particularly limited.

Furthermore, the gas accommodation portion 60 of the present disclosure is not limited to a case where the gas 8 is in contact with an inner surface of a wall portion (the end portion 51b of the first arcuate wall 51, the end portion 52b of the second arcuate wall 52, and the connection portion 53) constituting the gas accommodation portion 60. That is, the gas accommodation portion 60 includes a case where the heat absorbing agent 7 is attached to an inner surface of the wall portion constituting the gas accommodation portion 60. More specifically, a case where the gas 8 accommodated in the gas accommodation portion 60 is not in contact with an inner surface of the wall portion constituting the gas accommodation portion 60 due to the heat absorbing agent 7 attached to an inner surface of the wall portion constituting the gas accommodation portion 60 is also included. In the gas accommodation portion 60 as well, although heat is absorbed by the heat absorbing agent 7 attached to an inner surface of the wall portion constituting the gas accommodation portion 60, an amount of the heat is extremely small. This is because early melting of the gas accommodation portion 60 can be achieved in the same manner as in the embodiment. Note that, the present disclosure is preferable since melting of the gas accommodation portion 60 can be performed earlier when the heat absorbing agent 7 is not attached to an inner surface of the wall portion constituting the gas accommodation portion 60.

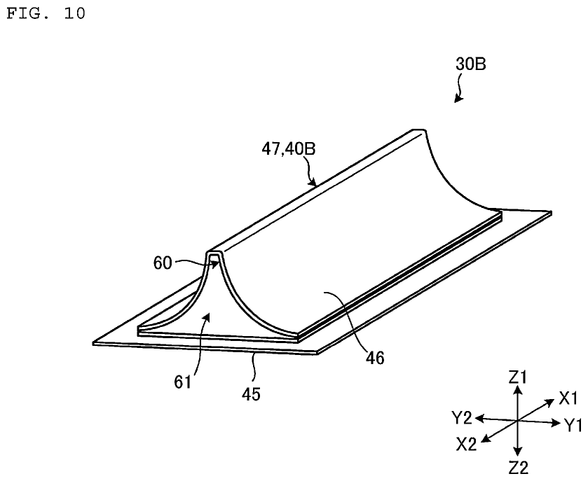

Next, an embedded member 30B of a second variation will be described according to an embodiment. FIG. 10 is a perspective view of the embedded member of the second variation. As illustrated in FIG. 10, the embedded member 30B of the second variation is different from the embedded member 30 of the first embodiment in that the number of projecting portions 47 of a container 40B is one. According to the second variation, it is possible to suppress induced explosion of two of the cylindrical cells 2 arranged in the width direction. Further, in a case where three of the embedded members 30B of the second variation are arranged in the width direction, it is possible to suppress induced explosion of four of the cylindrical cells 2 arranged in the width direction, similarly to the embedded member 30 of the first embodiment.

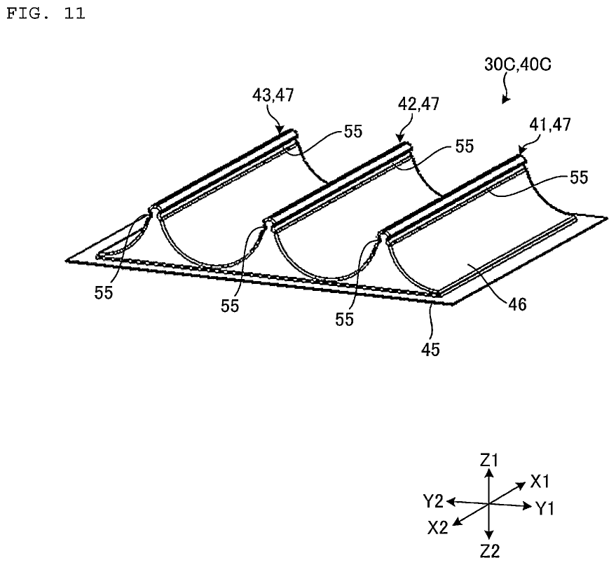

FIG. 11 is a perspective view of the embedded member of a third variation according to an embodiment. As illustrated in FIG. 11, an embedded member 30C of the third variation is different from the embedded member 30 of the first embodiment in that a protruding portion 55 is provided in the projecting portion 47. Note that the protruding portion 55 is provided on each of the first projecting portion 41, the second projecting portion 42, and the third projecting portion 43. Hereinafter, the protruding portion 55 provided on the first projecting portion 41 will be described as a representative example.

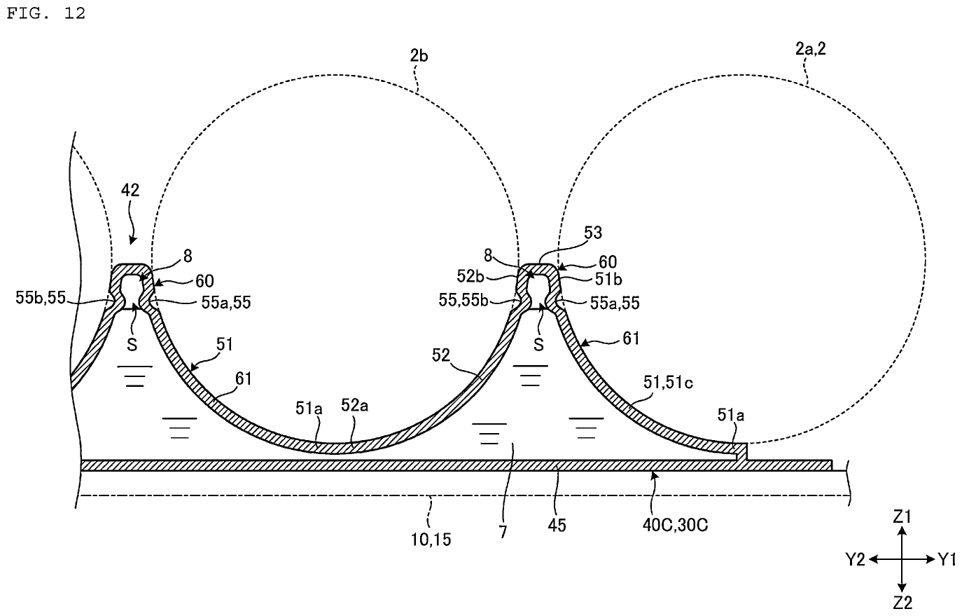

FIG. 12 is a sectional view of the first projecting portion of the third variation. FIG. 12 is a diagram obtained by extracting only the embedded member 30C from the battery pack. For this reason, the cylindrical cell 2 and the lower wall portion 15 arranged in the vicinity of the embedded member 30C are illustrated by a virtual line. As illustrated in FIG. 12, the protruding portion 55 includes a first protruding portion 55a formed by protruding a part of the first arcuate wall 51 into a container 40C, and a second protruding portion 55b formed by protruding a part of the second arcuate wall 52 into the container 40C. The first protruding portion 55a and the second protruding portion 55b extend over the entirety in the longitudinal direction of the first arcuate wall 51 and the second arcuate wall 52 (see FIG. 11).

The first protruding portion 55a and the second protruding portion 55b are at the same position in the vertical direction. That is, the first protruding portion 55a and the second protruding portion 55b face each other in the width direction. By the above, in the inside of the first projecting portion 41, a minute gap S is formed between the first protruding portion 55a and the second protruding portion 55b. Note that, in FIG. 12, the minute gap S is illustrated to be relatively large in order to make the minute gap S easy to see.

Further, positions in the vertical direction of the first protruding portion 55a and the second protruding portion 55b are at a boundary between the gas accommodation portion 60 and the heat absorbing agent accommodation portion 61. Therefore, the minute gap S is a space where the inside of the gas accommodation portion 60 and the inside of the heat absorbing agent accommodation portion 61 communicate with each other.

Further, the minute gap S (distance between the first protruding portion 55a and the second protruding portion 55b) has a width that makes it difficult for the heat absorbing agent 7 to pass through. In other words, in a case where the heat absorbing agent 7 is accommodated inside the frame portion 48 of the upper member 46 (see FIG. 5), the width is such that the heat absorbing agent 7 does not move toward the gas accommodation portion 60. Note that in a case where viscosity of the heat absorbing agent 7 to be used is high, the minute gap S is relatively large, and in a case where viscosity of the heat absorbing agent 7 to be used is low, the minute gap S is relatively small.

According to the embedded member 30C of the third variation, the heat absorbing agent 7 is hardly accommodated in the gas accommodation portion 60. Therefore, in a case where abnormal heat generation occurs in the cylindrical cell 2, the gas accommodation portion 60 reliably opens early. Further, since internal pressure of the container 40C increases due to abnormal heat generation of the cylindrical cell 2, when the heat absorbing agent 7 moves from the heat absorbing agent accommodation portion 61 to the gas accommodation portion 60, a space between the first protruding portion 55a and the second protruding portion 55b is expanded. Therefore, reduction in an amount of protrusion of the heat absorbing agent 7 is suppressed. Further, according to the third variation, there is no longer the limitation that a tip portion (the gas accommodation portion 60) of the projecting portion 47 is arranged to face the upper side Z1. That is, since the gas 8 is held inside the gas accommodation portion 60, a direction of a tip portion (the gas accommodation portion 60) of the projecting portion 47 can be freely set. Hereinafter, an example in which a tip portion of the projecting portion 47 is arranged to face the lower side Z2 will be described by using a fourth variation.

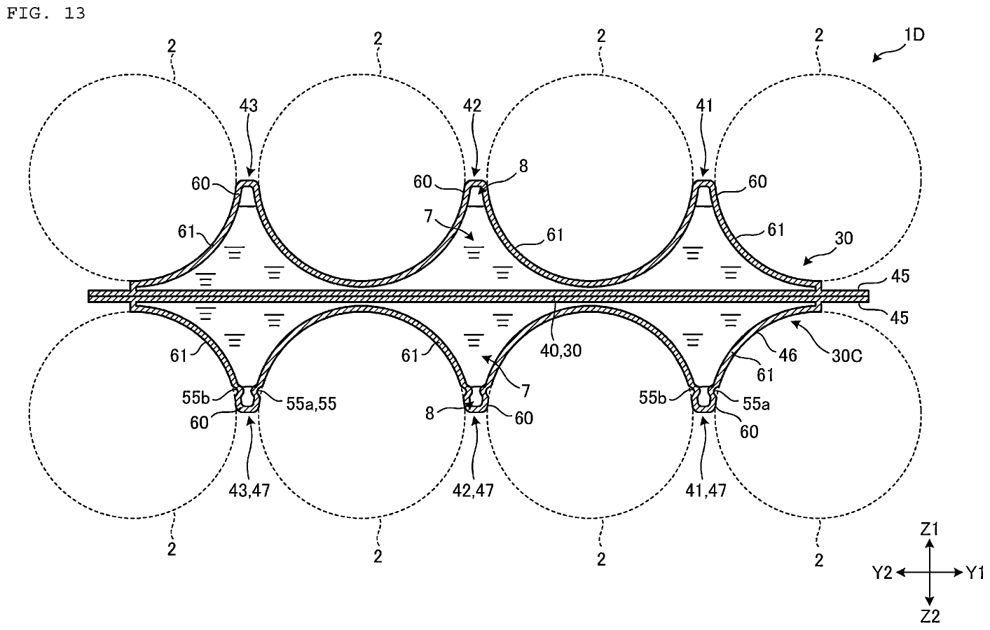

FIG. 13 is a diagram of the battery unit of a fourth variation as viewed from the longitudinal direction according to an embodiment. As illustrated in FIG. 13, a battery unit 1D according to the fourth variation includes eight of the cylindrical cells 2. Eight of the cylindrical cells 2 are arranged in two rows in the vertical direction and four rows in the width direction. Further, the battery unit 1D has two embedded members. One of the two embedded members is the embedded member 30 of the first embodiment. The other of the two embedded members is the embedded member 30C of the third variation.

The embedded member 30C is arranged in such a posture that the lower member 45 is located further on the upper side Z1 than the upper member 46. That is, a tip portion of the projecting portion 47 is arranged to face the lower side Z2. The embedded member 30 overlaps the upper side Z1 of the lower member 45 of the embedded member 30C. Then, the first projecting portion 41, the second projecting portion 42, and the third projecting portion 43 of the embedded member 30 are arranged between four of the cylindrical cells 2 arranged on the upper side Z1 among eight of the cylindrical cells 2. On the other hand, the first projecting portion 41, the second projecting portion 42, and the third projecting portion 43 of the embedded member 30C are arranged between four of the cylindrical cells 2 arranged on the lower side Z2 among eight of the cylindrical cells 2.

According to the fourth variation, the embedded member 30 suppresses induced explosion of four of the cylindrical cells 2 arranged on the upper side Z1 among eight of the cylindrical cells 2. Further, in the embedded member 30C, the gas 8 is held inside the gas accommodation portion 60 by a plurality of the protruding portions 55. Therefore, for four of the cylindrical cells 2 arranged on the lower side Z2 among eight of the cylindrical cells 2, induced explosion is suppressed by the embedded member 30C.

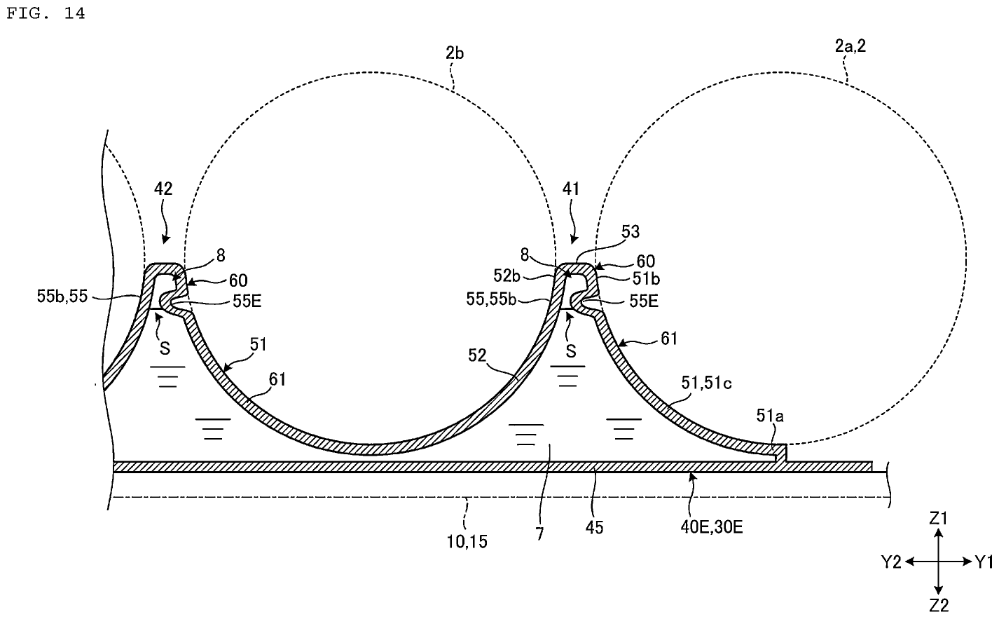

FIG. 14 is an enlarged diagram of the first projecting portion of a fifth variation according to an embodiment. As illustrated in FIG. 14, a container 40E of an embedded member 30E of the fifth variation is different from the embedded member 30C of the third variation in that the number of protruding portions 55E is reduced. Specifically, in the first projecting portion 41 of the container 40E, the protruding portion 55E is provided on the first arcuate wall 51. That is, the second arcuate wall 52 is not provided with the protruding portion 55E. Then, the minute gap S is formed between the second arcuate wall 52 and the protruding portion 55E. In the fifth variation as well, it is possible to prevent the heat absorbing agent 7 from being accommodated in the gas accommodation portion 60 as in the third variation. Note that, in the present disclosure, the protruding portion 55E may be provided not on the first arcuate wall 51 but on the second arcuate wall 52.

Note that an example in which the minute gap S is formed between the first protruding portion 55a and the second protruding portion 55b is described in the third variation, but in the present disclosure, the first protruding portion 55a and the second protruding portion 55b may abut on each other inside the container 40. According to the above, it is possible to reliably prevent the heat absorbing agent 7 from being accommodated in the gas accommodation portion 60. Further, also when the first protruding portion 55a and the second protruding portion 55b abut on each other, internal pressure of the container 40 increases due to abnormal heat generation of the cylindrical cell 2, and the first protruding portion 55a and the second protruding portion 55b are pushed apart. Therefore, the heat absorbing agent 7 smoothly moves toward the gas accommodation portion 60 and can be discharged from the container 40. Other than the above, portions in the longitudinal direction of the first protruding portion 55a and the second protruding portion 55b may abut on each other. Further, in the present disclosure, the protruding portion 55E described in the fifth variation may abut on the first arcuate wall 51 or the second arcuate wall 52.

Although the first embodiment and the first to fifth variations are described above, these are examples of suppressing induced explosion of the cylindrical cells 2 adjacent to each other in the width direction. Next, an embedded member capable of suppressing induced explosion of the cylindrical cells 2 adjacent in the vertical direction will be described.

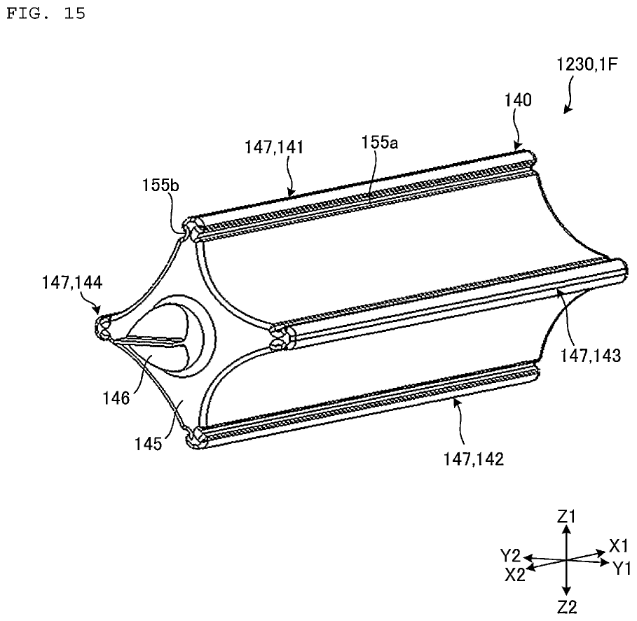

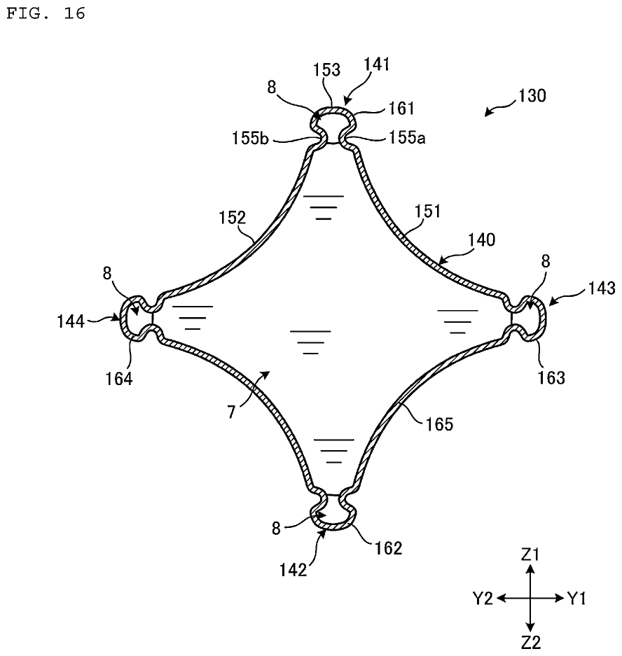

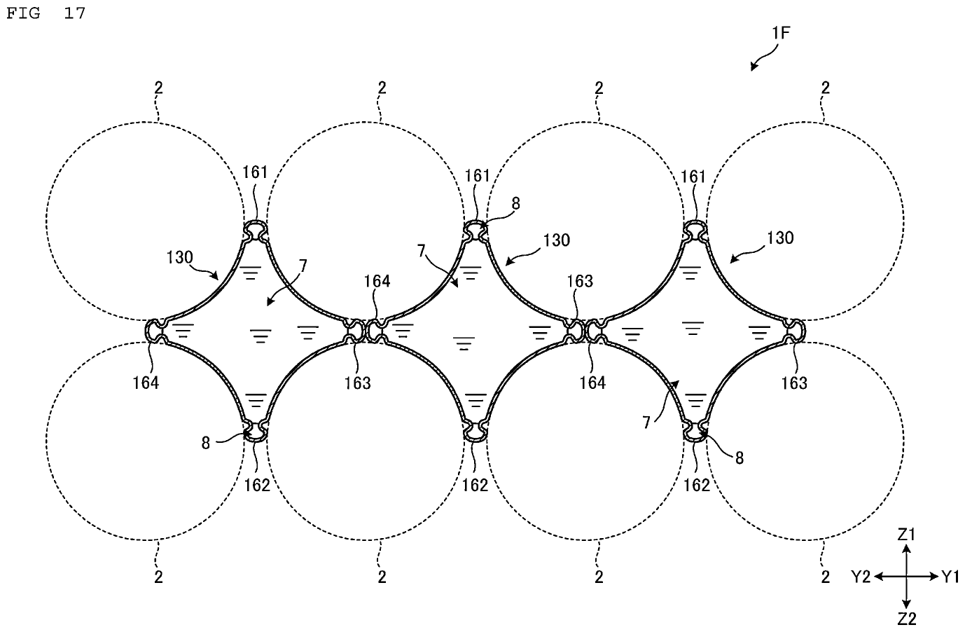

FIG. 15 is a perspective view of the embedded member of a second embodiment according to an embodiment. FIG. 16 is a sectional view of the embedded member of the second embodiment taken along the planar direction. FIG. 17 is a diagram of the battery unit of the second embodiment as viewed from the longitudinal direction. Note that FIG. 17 is a diagram in which only an embedded member 130 is extracted from the battery pack. For this reason, the cylindrical cell 2 arranged in the vicinity of the embedded member 130 is illustrated by a virtual line. Note that the embedded member 130 of the second embodiment is used in a battery unit 1F having eight of the cylindrical cells 2 as shown in the fourth variation (see FIG. 17).

In FIG. 15, a container 140 of the embedded member 130 has two side walls 145 (only one is illustrated in FIG. 15) arranged at both end portions in the longitudinal direction. A joining portion 146 is provided on the side wall 145 arranged in the second longitudinal direction X2 between two of the side walls 145. The joining portion 146 is formed by closing an accommodation port by thermal welding. That is, before being thermally welded, the joining portion 146 forms a cylindrical accommodation port where the inside and the outside of the container 140 communicate with each other. Note that the heat absorbing agent 7 and the gas 8 are accommodated in the container 140 by the accommodation port (joining portion 146).

The container 140 is provided with four projecting portions 147 projecting in four directions when viewed from the longitudinal direction. Four of the projecting portions 147 are arranged at intervals of 90° around the joining portion 146. Therefore, four of the projecting portions 147 include a first projecting portion 141 projecting to the upper side Z1, a second projecting portion 142 projecting to the lower side Z2, a third projecting portion 143 projecting in the first width direction Y1, and a fourth projecting portion 144 projecting in the second width direction Y2.

The first projecting portion 141, the second projecting portion 142, the third projecting portion 143, and the fourth projecting portion 144 have the same shape.

As illustrated in FIG. 16, the first projecting portion 141 has the same shape as the first projecting portion 41 of the third variation. That is, the first projecting portion 141 includes a connection portion 153 extending in the width direction, a first arcuate wall 151 arranged in the first width direction Y1 with respect to the connection portion 153, and the second arcuate wall 152 arranged in the second width direction Y2 with respect to the connection portion 153. The first arcuate wall 151 is provided with a first protruding portion 155a. The second arcuate wall 152 is provided with a second protruding portion 155b.

Further, the first arcuate wall 151 of the first projecting portion 141 forms the second arcuate wall 152 of the third projecting portion 143. The second arcuate wall 152 of the first projecting portion 141 forms the first arcuate wall 151 of the fourth projecting portion 144. That is, the first projecting portion 141, the second projecting portion 142, the third projecting portion 143, and the fourth projecting portion 144 share the first arcuate wall 151 and the second arcuate wall 152 with an adjacent one of the projecting portions 147.

From the above, an end portion on the upper side Z1 of the first projecting portion 141 forms a first gas accommodation portion 161. An end portion on the lower side Z2 of the second projecting portion 142 forms a second gas accommodation portion 162. An end portion in the first width direction Y1 of the third projecting portion 143 forms a third gas accommodation portion 163. An end portion in the second width direction Y2 of the fourth projecting portion 144 forms a fourth gas accommodation portion 164. A portion other than the first gas accommodation portion 161, the second gas accommodation portion 162, the third gas accommodation portion 163, and the fourth gas accommodation portion 164 of the container 140 forms a heat absorbing agent accommodation portion 165.

As illustrated in FIG. 17, in the battery unit 1F, three of the embedded members 130 are prepared for eight of the cylindrical cells 2. Each of the embedded members 130 is arranged between four of the cylindrical cells 2 adjacent to each other in the vertical direction and the width direction. Therefore, the first gas accommodation portion 161 is arranged between two of the cylindrical cells 2 arranged on the upper side Z1 and adjacent to each other in the width direction among four of the cylindrical cells 2. The second gas accommodation portion 162 is arranged between two of the cylindrical cells 2 arranged on the lower side Z2 and adjacent to each other in the width direction among four of the cylindrical cells 2. The third gas accommodation portion 163 is arranged between two of the cylindrical cells 2 arranged in the first width direction Y1 and adjacent to each other in the vertical direction among four of the cylindrical cells 2. The fourth gas accommodation portion 164 is arranged between two of the cylindrical cells 2 arranged in the second width direction Y2 and adjacent to each other in the vertical direction among four of the cylindrical cells 2. As described above, according to the second embodiment, it is also possible to suppress induced explosion of two of the cylindrical cells 2 adjacent to each other in the vertical direction.

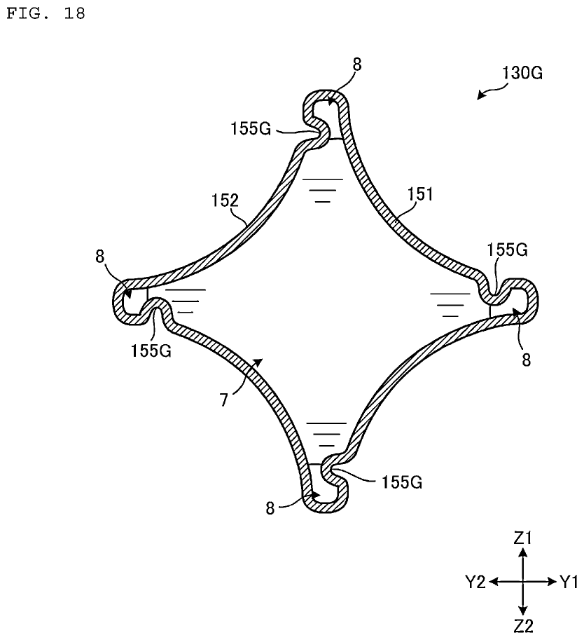

FIG. 18 is a sectional view of the embedded member of a sixth variation according to an embodiment. An embedded member 130G of the sixth variation is different from the embedded member 130 of the second embodiment in that a protruding portion 155G is provided on one of the first arcuate wall 151 and the second arcuate wall 152. In the sixth variation as well, it is possible to suppress induced explosion of two of the cylindrical cells 2 adjacent to each other in the vertical direction.

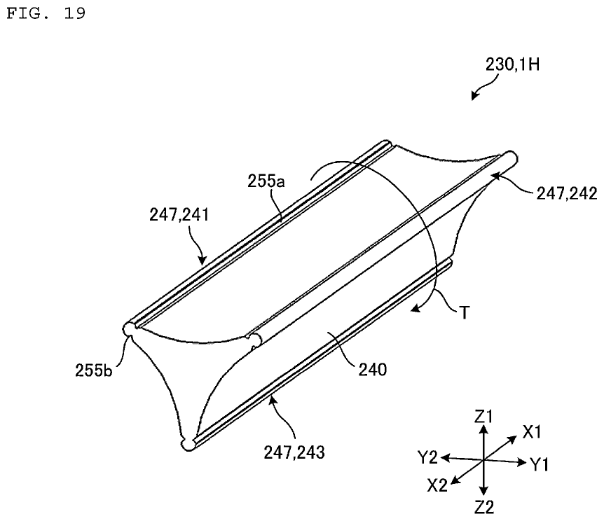

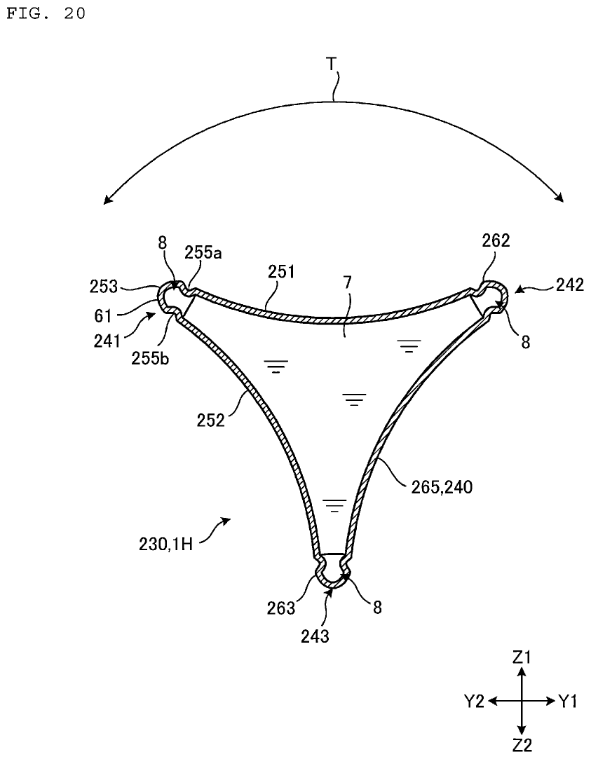

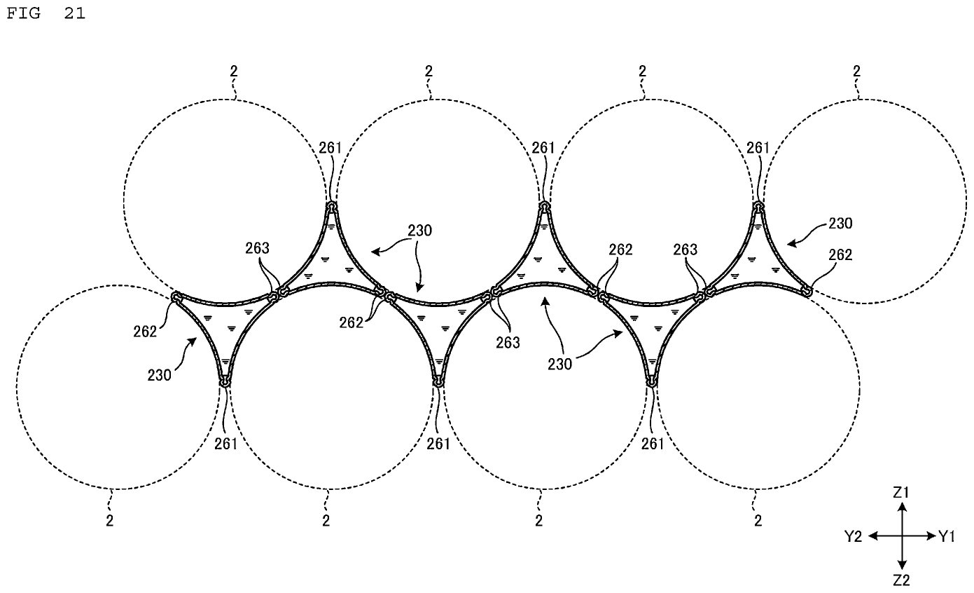

FIG. 19 is a perspective view of the embedded member of a third embodiment. FIG. 20 is a sectional view of the embedded member of the third embodiment taken along the planar direction. FIG. 21 is a diagram of the battery unit of the third embodiment as viewed in the longitudinal direction. Note that FIG. 21 is a diagram in which only an embedded member 230 is extracted from the battery pack. For this reason, the cylindrical cell 2 arranged in the vicinity of the embedded member 230 is illustrated by a virtual line. As illustrated in FIG. 21, the embedded member 230 of the third embodiment is used for a battery unit in which the cylindrical cell 2 arranged on the upper side Z1 and the cylindrical cell 2 arranged on the lower side Z2 are arranged to be shifted from each other in the width direction. Note that arrangement of the cylindrical cells 2 illustrated in FIG. 21 may be referred to as a straw ricebag pattern or a triangular lattice pattern.

As illustrated in FIG. 19, a container 240 of the embedded member 230 is provided with three projecting portions 247 projecting in three directions as viewed from the longitudinal direction. Three of the projecting portions 247 are arranged at intervals of 120° as viewed from the longitudinal direction. Therefore, three of the projecting portions 247 include a first projecting portion 241, a second projecting portion 242, and a third projecting portion 243 that are arranged in order in the clockwise direction (see an arrow T in FIGS. 19 and 20) when viewed from the second longitudinal direction X2. The first projecting portion 241, the second projecting portion 242, and the third projecting portion 243 have the same shape.

As illustrated in FIG. 20, the first projecting portion 241 includes a connection portion 253, a first arcuate wall 251 arranged in the clockwise direction T with respect to the connection portion 253, and a second arcuate wall 252 arranged in the counterclockwise direction with respect to the connection portion 253. The first arcuate wall 251 is provided with a first protruding portion 255a. The second arcuate wall 252 is provided with a second protruding portion 255b. Note that, also in the third embodiment, the first projecting portion 241, the second projecting portion 242, and the third projecting portion 247c share the first arcuate wall 251 and the second arcuate wall 252 with an adjacent one of the projecting portions 247.

From the above, a first gas accommodation portion 261 is provided at a tip portion of the first projecting portion 241. A second gas accommodation portion 262 is provided at a tip portion of the second projecting portion 242. A third gas accommodation portion 263 is provided at a tip portion of the third projecting portion 243. A portion other than the first gas accommodation portion 261, the second gas accommodation portion 262, and the third gas accommodation portion 263 of the container 240 forms a heat absorbing agent accommodation portion 265.

As illustrated in FIG. 21, six of the embedded members 230 are prepared for eight of the cylindrical cells 2. The embedded member 230 is arranged between three of the cylindrical cells 2 arranged in a triangular lattice shape. The three of the cylindrical cells 2 are two of the cylindrical cells 2 adjacent to each other in the width direction, and one of the cylindrical cell 2 arranged in the middle in the width direction and shifted in the vertical direction with respect to the two of the cylindrical cells 2. That is, one of three of the cylindrical cells 2 is adjacent in the width direction, and the other two are adjacent in an oblique direction. Note that the oblique direction is a direction in which a position in the vertical direction changes toward the width direction.

Then, in the third embodiment, in a case where the first gas accommodation portion 261 is arranged between the adjacent cylindrical cells in the width direction, the remaining second gas accommodation portion 262 and third gas accommodation portion 263 are arranged between the adjacent cylindrical cells 2 in the oblique direction. From the above, according to the third embodiment, it is possible to prevent induced explosion of two of the cylindrical cells 2 adjacent to each other in the oblique direction.

Although each embodiment and each variation are described above, in the present disclosure, the connection portion (gas accommodation portion) may be arranged to be shifted from a narrowest place between two adjacent ones of the cylindrical cells 2. Further, in the present disclosure, a wall portion constituting the gas accommodation portion may be made smaller in thickness than a wall portion constituting the heat absorbing agent accommodation portion, and the gas accommodation portion may be more easily opened. Note that the gas accommodation portion is constituted by wall portions of the connection portion 53, the end portion 51b near the connection portion 53 of the first arcuate wall 51, and an end portion 52b near the connection portion 53 of the second arcuate wall 52 (see FIG. 6). Further, the heat absorbing agent accommodation portion is constituted by wall portions of a portion excluding the end portion 51b of the first arcuate wall 51 and a portion excluding the end portion 52b of the second arcuate wall 52 (see FIG. 6).

### DESCRIPTION OF REFERENCE SYMBOLS

1, 1D, 1F, 1H: Battery unit
2: Cylindrical cell
7: Heat absorbing agent
8: Gas
10: Cell holder
20: Tab
30, 30A, 30B, 30C, 30E, 130, 230: Embedded member
40, 40B, 40E, 140, 240: Container
41, 141, 241: First projecting portion
42, 142, 242: Second projecting portion
43, 143, 243: Third projecting portion
45: Lower member
46: Upper member
47, 147, 247: Projecting portion
48: Frame portion
51, 151, 251: First arcuate wall
52, 152, 252: Second arcuate wall
53, 153, 253: Connection portion
55, 55E: Protruding portion
55a, 155a, 255a: First protruding portion
55b, 155b, 255b: Second protruding portion
60: Gas accommodation portion
61, 165, 265: Heat absorbing agent accommodation portion
62: Tear
100: Battery pack
101: Case
144: Fourth projecting portion
161, 261: First gas accommodation portion
162, 262: Second gas accommodation portion
163, 263: Third gas accommodation portion
164: Fourth gas accommodation portion
S: Minute gap

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a plurality of cylindrical cells arranged in a manner that electrode terminals face a same direction; and
an embedded member arranged between a plurality of the cylindrical cells,
wherein the embedded member includes a container, and gas and a heat absorbing agent accommodated inside the container,
the container is provided with a projecting portion arranged between two of the cylindrical cells adjacent to each other and extending in a longitudinal direction of the cylindrical cell as viewed in the longitudinal direction of the cylindrical cell,
the projecting portion includes:
a heat absorbing agent accommodation portion in which the heat absorbing agent is accommodated; and
a gas accommodation portion in which the gas is accommodated, and
the gas accommodation portion is arranged at a tip portion of the projecting portion and is in contact with each of two of the cylindrical cells adjacent to each other.

2. The battery pack according to claim 1, wherein the heat absorbing agent is not attached to an inner surface of a wall portion constituting the gas accommodation portion.

3. The battery pack according to claim 1, wherein the gas accommodation portion is arranged at a narrowest place between two adjacent ones of the cylindrical cells.

4. The battery pack according to claim 1, wherein the gas accommodation portion abuts on an entirety in the longitudinal direction of a side surface of two adjacent ones of the cylindrical cells.

5. The battery pack according to claim 1, wherein gas accommodated in the gas accommodation portion is continuous in the longitudinal direction.

6. The battery pack according to claim 1, wherein the gas accommodated in the gas accommodation portion is continuous over an entirety in the longitudinal direction of the projecting portion.

7. The battery pack according to claim 1, wherein thickness of a wall portion constituting the gas accommodation portion is smaller than thickness of a wall portion constituting the heat absorbing agent accommodation portion.

8. The battery pack according to claim 1, wherein
the projecting portion at least includes:
a first arcuate wall extending along an outer peripheral surface of one of two adjacent ones of the cylindrical cells;
a second arcuate wall extending along an outer peripheral surface of another one of two adjacent ones of the cylindrical cells; and
a connection wall arranged between two adjacent ones of the cylindrical cells and connecting the first arcuate wall and the second arcuate wall.

9. The battery pack according to claim 8, wherein
at least one of the first arcuate wall and the second arcuate wall is provided with a protruding portion projecting into the container, and
the protruding portion is provided at a boundary between the heat absorbing agent accommodation portion and the gas accommodation portion.

10. The battery pack according to claim 1, wherein the container is made from resin.

11. The battery pack according to claim 1, wherein the heat absorbing agent contains water as a main component.

12. The battery pack according to claim 1, wherein a form of the heat absorbing agent is gel or sol.
